(19) United States
(12) Patent Application Publication
(10) Pub. No.: US 2024/0027098 A1
(43) Pub. Date: Jan. 25, 2024

(54) MULTI-PASS HEATER

(71) Applicant: HC THERMAL LLC, Cypress, TX (US)

(72) Inventors: David GRIFFITH, Cypress, TX (US); Lejun HE, Jiangsu Province (CN)

(21) Appl. No.: 18/265,036

(22) PCT Filed: Dec. 3, 2020
(86) PCT No.: PCT/US20/62985

§ 371 Date: Jun. 2, 2023

(51) Int. Cl. F24H 3/04; F24H 9/16

(52) U.S. Cl. CPC F24H 3/0405; F24H 9/16; F24H 2250/02

(57) ABSTRACT

In one non-limiting embodiment, an apparatus is provided wherein the apparatus has a shell defining an interior volume, the shell having a first flange and a second flange. The apparatus may also be configured with an end cap having a connection flange, the end cap connected to the shell at the second flange. The apparatus may also be tunable to allow different heat amounts to be generated and exposed to fluid carried in tubes within the interior volume.

### CROSS REFERENCE TO RELATED APPLICATIONS

None.

### STATEMENT REGARDING FEDERALLY SPONSORED RESEARCH OR DEVELOPMENT

None,

### FIELD OF THE DISCLOSURE

Aspects of the disclosure relate to heaters. More specifically, aspects of the disclosure relate to a multi-pass heater used in various industries to heat fluids to desired temperatures.

### BACKGROUND INFORMATION

Heating of fluids is an important function in many industrial and commercial processes. Heating can be expensive for many customers as the capital costs of devices to heat fluids have skyrocketed in recent history. To prevent unwanted expenses, customers needing heated fluids desire to conduct such heating with as minimal capital cost as possible.

Companies also desire to have processes that are “green”, wherein conservation of resources is pursued. Eliminating waste from an environmental basis allows a company to promote an environmental record that some customers find appealing. Reducing the size or footprint of devices used in manufacturing is highly beneficial.

While the above factors are important, designers try to identify opportunities wherein fluids may be heated with the above requirements being met, while maintaining an economic advantage compared to conventional systems.

There is a need to provide a multi-pass heater that will allow heating of fluids in a small footprint design.

There is a further need to provide a multi-pass heater that is also economical to produce.

There is a further need to provide a multi-pass heater that is simplified in its construction compared to conventional apparatus.

There is a further need to provide a multi-pass heater that may be constructed by individuals without need for special training.

There is a further need to provide a multi-pass heater that may be field serviced with ease, thereby reducing maintenance costs.

There is a further need to provide a multi-pass heater that will withstand the rigors of environmental conditions that the heater is exposed to and provide a superior length of service compared to conventional heaters.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one embodiment, an apparatus is disclosed. The apparatus comprises a shell defining an interior volume, the shell having a first vessel flange and a second vessel flange. The apparatus further comprises a vessel end cap assembly comprising a vessel end cap flange and an outlet nozzle, the end cap assembly connected to the second vessel flange. The apparatus further comprises a heater element flange connected to the first vessel flange of the shell, the heater element flange having at least one penetration through the flange. The apparatus further comprises at least one overtube configured with an inlet and an outlet. The apparatus further comprises at least one resistive heating element placed inside the at least one overtube and passing through the at least one penetration of the heater element flange, wherein the at least one resistive heating element is connected to the heating element flange, the at least one resistive heating element configured to heat a fluid passing through an annulus area between the at least one overtube and the at least one resistive heating element.

In another example embodiment, a method of operating a heater is disclosed. The method may comprise providing an unheated fluid to a first port of the heater, passing the unheated fluid through an annular space between a resistive heating element and an overtube arrangement, energizing the resistive heating element within the heater; producing a heat by the resistive heating element of the heater; conducting the heat to the fluid as the fluid transports through the annular space between the first port to a second port; and transporting the fluid out of the second port.

Other aspects and advantages will become apparent from the following description and the attached claims.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not to be considered limiting of its scope, for the disclosure may admit to other equally effective embodiments.

FIG. 1 is a side view of a multi-pass heater in accordance with one example embodiment of the disclosure.

FIG. 2 is an end view of the multi-pass heater of FIG. 1.

FIG. 3 is a flange immersion heater assembly of FIG. 1.

FIG. 4 is a side view of the multi-pass overtube configuration with radiation shield of FIG. 1.

FIG. 5 is a flow chart for a process of heating a fluid with a multi-pass heater in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims, except where explicitly recited in a claim. Likewise, reference to “the disclosure” shall not be construed as a generalization of inventive subject matter disclosed herein and shall not be considered to be an element or limitation of the claims, except where explicitly recited in a claim.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure relate to heaters. More specifically, aspects of the disclosure relate to heaters that may be “tuned” to provide various heating features that maximize desired heating for fluids. These heaters may be used in various commercial and/or industrial settings, and the embodiments disclosed herein should not be considered limiting. By way of example, a heater may be “tuned” by changing various characteristics of spaces surrounding heating elements or overtube devices to transfer heat to a fluid flowing past an internally contained heating element. In some embodiments, the fluid heated may be a water or demineralized water. Other fluids may be heated with the heater embodiments disclosed. Fluids may be classified as gases, liquids and combinations of liquids and gasses in non-limiting embodiments. The heaters disclosed allow for a fine tuning of heat input to the fluid, thereby creating a very accurate control of the heating occurring. Alterations of the designs disclosed are permitted to provide different heating characteristics. As a non-limiting embodiment, tubes placed within the heater may have thicker or thinner cross-sections. These thicker or thinner cross-sections may allow for higher pressure ratings of the heater and greater or lesser heat transfer. Moreover, thinner cross-sections may allow for lighter weight that will allow for the heater to placed in places where access is difficult for installers.

Other embodiments of the disclosure provide for a tunable electric heater that solves many issues with conventional heaters. Conventional heaters, for example, have difficulty processing low flows and/or large thermal change heating scenarios. These parameters, for example, require complete changes in process design. For example, in instances where a large increase in temperature is to be imparted into a fluid stream, multiple heaters are used as “steps”, for conventional applications, to more gradually increase a fluid temperature. Often times, there is an insufficient amount of space for location of multiple heaters. In conventional embodiments where a single heater is used, the pressure boundary (exterior shell) of the heater may become extremely hot, complicating the design and creating a worker safety issue. Embodiments of the aspects herein solve these concerns as a single vessel may be used to perform heating functions of fluids.

In embodiments described herein, the vessel for the heater allows for the process to flow along the main pressure boundary wall to cool the wall while gaining heat from the internals of the design. In embodiments, a radiation shield may be used to assure that heat from electric elements and tubes does not transmit to the pressure boundary wall.

Aspects of the disclosure may be modified to allow significant storage space for a total volume of fluid being processed. Sizes of the described embodiments may be increased or decreased according to the amount of heat and flow volume of fluid being processed, therefore the described embodiments should not be considered limiting. Moreover, aspects of the disclosure may recite optional components for the design, therefore the disclosure should not be considered limiting.

The tunable design allows for a variance of an annular space between the electric heating element tube and an overtube design to produce a desired velocity for the fluid being processed and the amount of heat being transferred to the fluid. In this type of embodiment, design parameters of the multi-pass heater may be altered to provide for the amount of heating required by the user. As a non-limiting embodiment, where a desired heating capability is large, the annular space between the electric heating element and the internal tube carrying the liquid may be minimized to provide quick heating of the fluid. In some embodiments, the length of exposure between the fluid and the heating tube may be increased, thereby allowing greater exposure of the fluid to heat generated by the heating element. In some embodiments, the electric element electrical input may be varied to provide a greater amount of current, without having to reduce the size of the annular space between the electric heating element and the tube/tubes carrying fluid.

In the illustrated embodiments, the multi-pass heater may be disassembled with minimal effort by field installation personnel. Elements within the heater may be cleaned to ensure further capability to conduct heat. In the illustrated embodiments, different configurations are possible. Such embodiments may include differing numbers of heating elements, differing numbers of tubes and different amounts of space between heating elements and tubes as non-limiting examples. In the illustrated embodiments, for example, three heating elements are illustrated. A lesser or greater number of heating elements may be used, and as such, should be considered part of the disclosure.

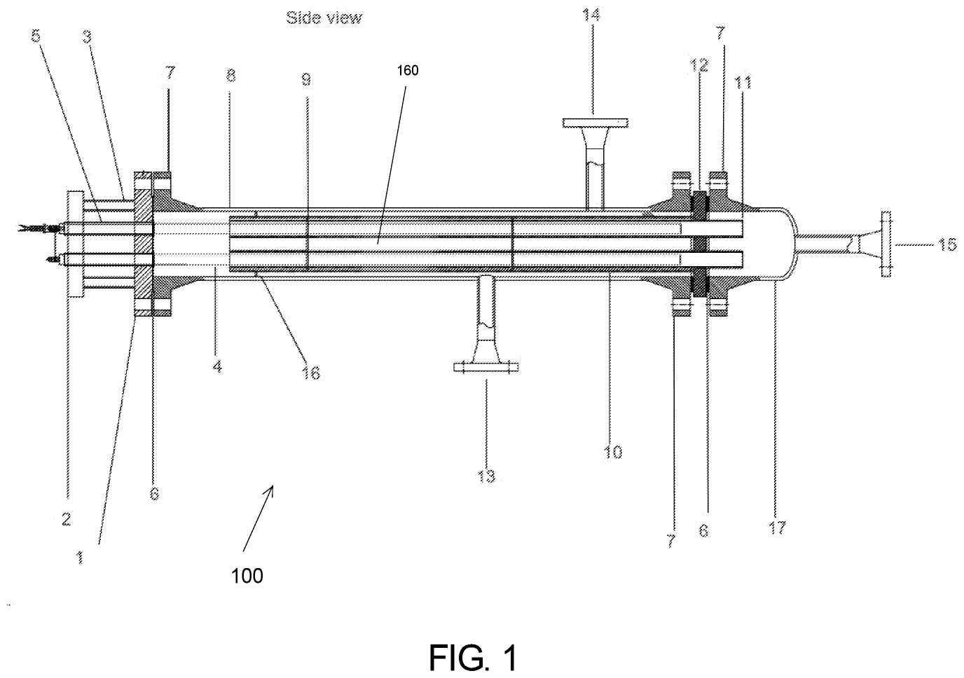

FIG. 1 illustrates a side view of the heater 100 in one example aspect of the disclosure. A shell 8 provides a boundary that defines an interior volume 160. The heater has two vessel flanges 7. These two vessel flanges 7 may be identical. For purposes of description the left most flange is described as a first vessel flange and the right most flange is described as a second vessel flange. A vessel end cap assembly 17 is connected to the heater 100. The heater 100 also has an inlet nozzle 14 and an outlet nozzle 15. A drain nozzle 13 is furthermore provided as a drain for the heater 100. The inlet nozzle 14 is used first to accept a fluid into the heater 100. As will be understood, both a liquid and/or a gas may enter the inlet nozzle 14. A vessel end cap assembly 17 is provided to the outlet nozzle 15. The outlet nozzle 15 allows fluid to exit the heater 100. Heat may be conducted to the fluid traversing from the inlet nozzle 14 to the outlet nozzle 15 by a resistive heating element 4. The space in which the fluid may traverse is the area near the resistive heating element 4. The resistive heating element 4 is located within the heater 100 and supported as illustrated in FIG. 1. Overtubes 11 are supported by an overtube sheet spacer support 9. The vessel end cap 17 connects to the vessel flange 7 of the shell 8. The vessel end cap assembly 17 may be connected to the body shell 8 through a set of bolts (unnumbered for clarity of drawing) that pass through bolt holes through a vessel flange 7. In other embodiments, the vessel end cap assembly 17 may be welded or otherwise attached to the vessel shell 8. In a like manner, a set of bolts may pass through matching bolt holes for the immersion heater flange 1 and the first flange 7. As will be understood, the number of bolts in the set of bolts for both connections described above may be increased or decreased according to the service conditions. A drain nozzle 13 is also provided to allow drainage of the body shell 8 in instance where emptying is necessary, such as, in a non-limiting embodiment, maintenance of the heater 100. In embodiments, an immersion heater flange 1 is provided near a terminal housing flange 2. As illustrated, a terminal housing flange support tube 3 is arranged between the terminal housing flange 2 and the immersion heater flange 1.

Gaskets may be provided with the designs, as illustrated. A flange gasket 6 may be installed between the vessel end cap assembly 17 and the vessel flange 7 as well as the left most vessel flange 7 and the immersion heater flange 1. A radiation shield 10 may also be installed to limit radiation of heat from the overtubes 11 to the body shell 8 and to the external environment.

An overtube 11 is used in conjunction with the resistive heating element 4 such that an annulus is created between the overtube 11 and the resistive heating element 4. One overtube may be used for each resistive heating element. The number of resistive heating elements may be varied from a single unit to multiple units. The number of overtubes matches the number of resistive heating elements used. Overtubes 11 are held in position by spacers 9 and an overtube assembly centering spacer 16. Although shown as a single spacer 16, multiple numbers of spacers 16 may be used for longer designs. An overtube flange 12 is arrangement to allow the overtubes 11 to be supported within the heater 100. The overtube flange 12 is configured to be kept in place through compression exerted from the bolts that connect the vessel end cap assembly 17 and the vessel flange 7. A heating element tube sheet 5 is provided to maintain space between portions of the resistive heating elements 4 used for heating the working fluid.

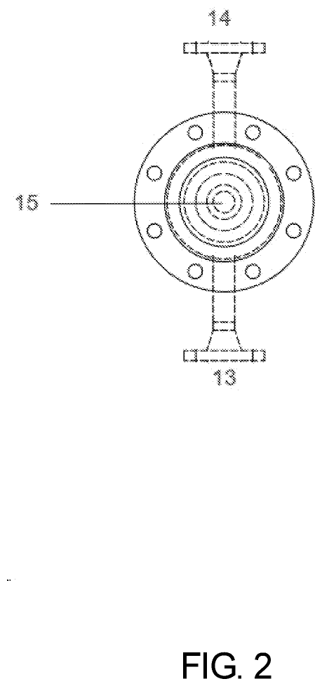

Referring to FIG. 2, a cross-section of the heater of FIG. 1 is illustrated. In this cross-sectional view, the vessel shell 8 surrounds three resistive heating elements 4 that are surrounded by overtubes 11. The positioning of the resistive heating elements 4 allows for the heating of fluids that pass between the annular space created between the resistive heating element 4 and the overtubes 11. As will be understood, different amounts of current may be used with the resistive heating elements 4 to achieve greater or lesser amounts of heat. As will be understood, electrical voltage, current and resistance may be altered as well. The resistive heating elements 4 may be based upon placement of resistors that generate heat when a current is applied to the resistor. In embodiments, referring to FIG. 1, fluid flows from the inlet nozzle 14 to the outlet nozzle 15. The fluid, as it passes along the area adjacent to the resistive heating elements 4, is heated where the fluid is then collected in the vessel end cap assembly 17 and exits the outlet nozzle 15. The system is described as “tunable” wherein the spacing of the annular area between the resistive heating elements 4 and the overtubes 11 may be varied. As a result of this construction, higher temperatures may be reached for smaller size units, thereby presenting an advantage over conventional units. In some embodiments, a radiation shield 10 may be used to alter heat transfer. An additional annular space may be added in embodiments using a radiation shield 10, thus keeping radiation from the pressure vessel.

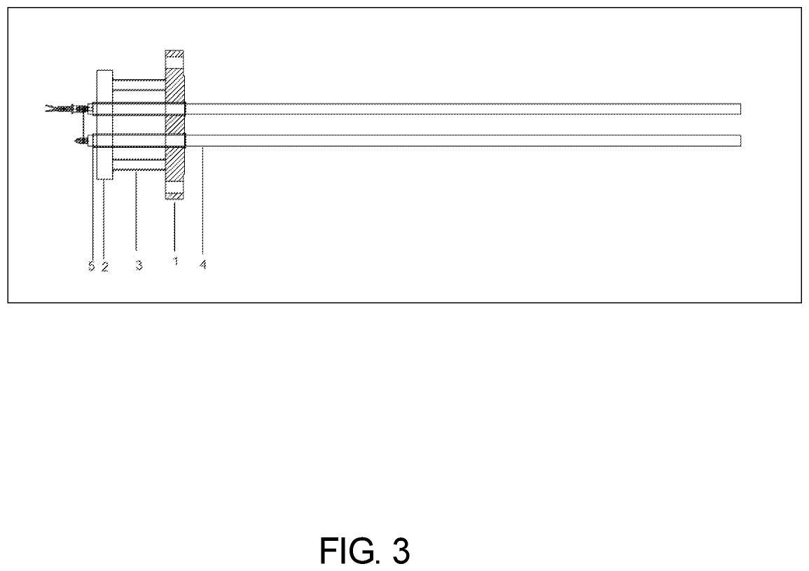

Referring to FIG. 3, further details of the heating of the heater 100 are illustrated. Resistive heating elements 4 are supported by a terminal housing flange 2, a heating element tube sheet 5, and a terminal housing flange support tube 3. This configuration is present when a “stand off” is needed, where the ends of the resistive heating elements 4 are located away from immersion heater flange 1. In other embodiments, the terminal housing flange support tube 3 and the terminal housing flange 2 may be omitted. As will be understood, instead of bolted connections connecting the different described flanges, welded connections may be used.

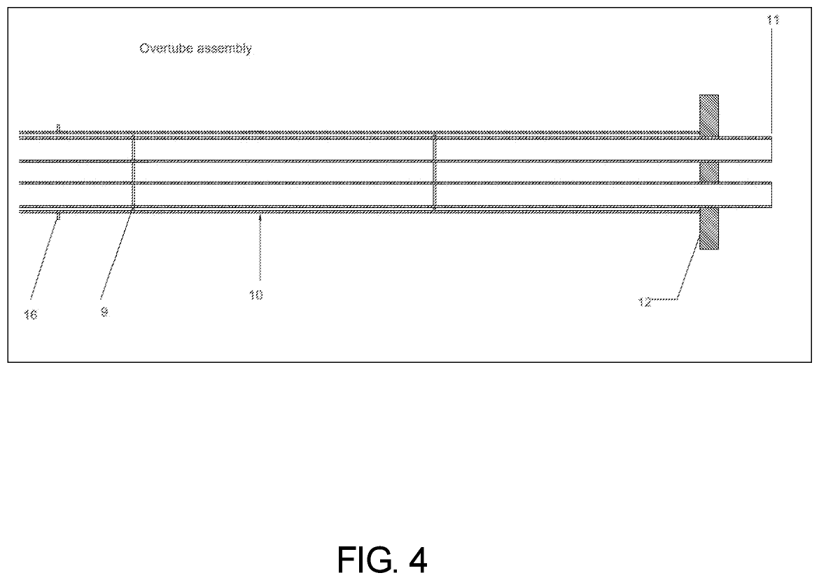

Referring to FIG. 4, a multi-pass tube with radiation shield 10 is illustrated. In this illustrated embodiment, the radiation shield 10 protects the remainder of the pressure vessel boundary from heat that was generated by the resistive heating element 4. In conventional apparatus, heat is allowed to pass to the wall of the heater 100, requiring special precautions in placement of the heater 100. Such a construction may allow for addition of a tunable passage to manage fluid flow. In the embodiments provided herein, however, heat is prevented from reaching the shell 8, thereby improving upon conventional apparatus. As illustrated, a spacer support 9 is provided to keep the individual overtubes 11 aligned with the radiation shield 10. As previously discussed, the presence of a radiation shield 10 may be considered an option and is not required by the heater 100. An overtube assembly centering spacer 16 is provided to allow for support between the body shell 8 and the radiation shield 10.

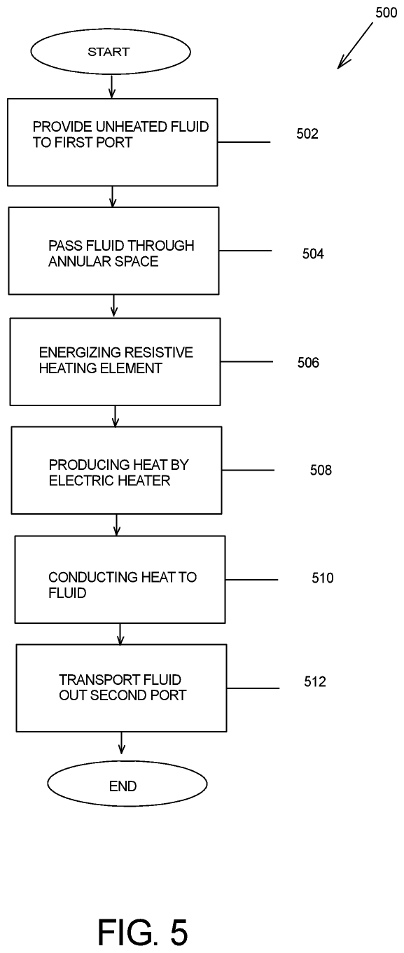

Referring to FIG. 5, an example embodiment of a method 500 of operating a heater 100 is disclosed. At 502, the method recites for providing an unheated fluid to a first port of the heater. At 504, the method recites passing the fluid through an annular space between a heating element and an overtube arrangement. At 506, the method recites energizing a resistive heating element within the heater. As will be understood, the energizing of the element heater may be accomplished simultaneously to the step 504 or the energizing may be done prior to step 504. At 508, the method recites producing a heat by the electric heater. At 510, the method recites conducting the heat through the electric heater to the fluid as the fluid transports through the annular space between the first port to the second port. At 512, the method recites transporting the fluid out of the second port.

In the aspects described above, a multi-pass heater is provided that will allow heating of fluids in an environmentally friendly manner.

In the aspects described above, a multi-pass heater is provided that is also economical to produce.

In the aspects described above, a multi-pass heater is provided t in its construction compared to conventional apparatus.

In the aspects described above, a multi-pass heater is provided that may be constructed by individuals without need for special training.

In the embodiments disclosed, the multi-pass heater will withstand the rigors of environmental conditions that the heater is exposed to and provide a superior length of service compared to conventional heaters.

In one embodiment, an apparatus is disclosed. The apparatus comprises a shell defining an interior volume, the shell having a first flange and a second flange and a first fluid port. The apparatus further comprises an end cap assembly comprising a vessel flange and a second fluid port, the end cap assembly connected to the shell at the second flange with the vessel flange. The apparatus further comprises a heater element flange connected to the first flange of the shell, the heater element flange having at least one penetration through the flange. The apparatus further comprises at least one overtube configured with an inlet and an outlet. The apparatus further comprises at least one resistive heating element placed inside the overtube and passing through the at least one penetration of the heater element flange, wherein the at least one resistive heating element connected to the heating element flange, the at least one resistive heating element configured to heat a fluid passing through an annulus area between the at least one overtube and the at least one resistive heating element.

In another example embodiment, the apparatus may further comprise at least one drain nozzle connected to the shell.

In another example embodiment, the apparatus may further comprise at least one spacer placed at least partially between the shell and the at least one overtube.

In another example embodiment, the apparatus may further comprise at least two terminal housing flange support tubes and a terminal housing flange, wherein the at least two terminal housing flange support tubes are connected to the heater element flange and the terminal housing flange.

In another example embodiment, the apparatus may further comprise a heating element stand off tube, the heating element stand off tube connected to the terminal housing flange.

In another example embodiment, the apparatus may be configured wherein the shell is made of at least one of carbon steel, a metal, stainless steel and steel alloys.

In another example embodiment, the apparatus may be configured wherein the overtubes are configured to be removed from the interior volume of the shell.

In another example embodiment, the apparatus may be configured wherein the heater element flange and the first flange are configured with a set of bolt holes.

In another example embodiment, the apparatus may further comprise a first bolts connecting the heater element flange and the first flange.

In another example embodiment, the apparatus may be configured wherein the vessel flange and the second flange are configured with a set of bolt holes.

In another example embodiment, the apparatus may be further configured with a second set of bolts connecting the vessel flange and the second flange.

In another example embodiment, a method of operating a heater is disclosed. The method may comprise providing an unheated fluid to a first port of the heater, passing the unheated fluid through an annular space between a resistive heating element and an overtube arrangement, energizing the resistive heating element within the heater; producing a heat by the resistive heating element of the heater; conducting the heat to the fluid as the fluid transports through the annular space between the first port to a second port; and transporting the fluid out of the second port.

In another example embodiment, the method may further comprise transporting the unheated fluid from the first port to one end of the heating element.

In another example embodiment, the method may be performed wherein the fluid is a gas.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

1. An apparatus, comprising:
a shell defining an interior volume, the shell having a first vessel flange and a second vessel flange;
a vessel end cap assembly comprising a vessel end cap flange and an outlet nozzle, the end cap assembly connected to the shell at the second vessel flange;
a heater element flange connected to the first vessel flange of the shell, the heater element flange having at least one penetration through the flange;
at least one overtube configured with an inlet and an outlet, and
at least one resistive heating element placed inside the at least one overtube and passing through the at least one penetration of the heater element flange, wherein the at least one resistive heating element is connected to the heating element flange, the at least one resistive heating element configured to heat a fluid passing through an annulus area between the at least one overtube and the at least one resistive heating element, wherein the overtubes are configured to be removed from the interior volume of the shell.

2. The apparatus according to claim 1, further comprising at least one drain nozzle connected to the shell.

3. The apparatus according to claim 1, further comprising:
at least one spacer placed at least partially between the shell and the at least one overtube.

4. The apparatus according to claim 1, further comprising:
at least two terminal housing flange support tubes; and
a terminal housing flange, wherein the at least two terminal housing flange support tubes are connected to the heater element flange and the terminal housing flange.

5. The apparatus according to claim 4, further comprising:
at least one heating element standoff tube, the two heating element standoff tubes connected to the terminal housing flange.

6. The apparatus according to claim 5, wherein the shell is made of at least one of carbon steel, stainless steel, a metal and steel alloys.

7. (canceled)

8. The apparatus according to claim 1, wherein the heater element flange and the first flange are configured with a set of bolt holes.

9. The apparatus according to claim 8, further comprising:
a first set of bolts connecting the heater element flange and the first flange.

10. The apparatus according to claim 1, wherein the vessel flange and the second flange are configured with a set of bolt holes.

11. The apparatus according to claim 10, further comprising:
a second set of bolts connecting the vessel flange and the second flange.

12. The apparatus according to claim 1, wherein the vessel flange and the second flange are welded.

13. A method of operating a heater, comprising:
providing an unheated fluid to a first port of the heater, wherein the fluid is a gas;
passing the unheated fluid through an annular space between a resistive heating element and an overtube arrangement,
energizing the resistive heating element within the heater;
producing a heat by the resistive heating element of the heater;
conducting the heat to the fluid as the fluid transports through the annular space between the first port to a second port; and
transporting the fluid out of the second port.

14. The method according to claim 13, further comprising:
transporting the unheated fluid from the first port to one end of the heating element.

15. (canceled)
